(19) United States
(12) Patent Application Publication
(10) Pub. No.: US 2026/0295938 A1
(43) Pub. Date: Oct. 1, 2026

(54) Three-Dimensional Object Printing Apparatus And Head Unit

(71) Applicant: SEIKO EPSON CORPORATION, Tokyo (JP)

(72) Inventors: Yoshinori NAKAJIMA, Matsumoto (JP); Masaru KUMAGAI, Shiojiri (JP)

(21) Appl. No.: 19/629,162

(22) Filed: Mar. 26, 2026

(30) Foreign Application Priority Data
Mar. 27, 2025 (JP) 2025-053129

(51) Int. Cl. B29C 64/209; B29C 64/112; B29C 64/255; B29C 64/321; B33Y 30/00

(52) U.S. Cl. CPC B29C 64/209; B29C 64/112; B29C 64/255; B29C 64/321; B33Y 30/00

(57) ABSTRACT

A three-dimensional object printing apparatus includes a head unit including a head that discharges liquid, and a robot that moves the head unit with respect to a workpiece in a state in which the head unit is mounted on the robot. The head unit includes a coupling portion that is coupled to a distal end of the robot. The head includes a nozzle surface provided with a nozzle that discharges the liquid. The nozzle surface is positioned at a lower end of the head unit in a direction perpendicular to the nozzle surface. An upper end of the coupling portion is positioned between an upper end and the lower end of the head unit in the direction.

The present application is based on, and claims priority from JP Application Serial Number 2025-053129, filed Mar. 27, 2025, the disclosure of which is hereby incorporated by reference herein in its entirety.

### BACKGROUND

### 1. Technical Field

The present disclosure relates to a three-dimensional object printing apparatus and a head unit.

### 2. Related Art

In the related art, a three-dimensional object printing apparatus that performs printing on a surface of a three-dimensional workpiece via an ink jet method using a robot is known. For example, JP-A-2023-065834 discloses a printing apparatus including a head unit including a head that discharges ink, and a robot that changes a position and a posture of the head unit mounted at a distal end.

In a three-dimensional object printing apparatus, since a head unit mounted at a distal end of an arm of a robot can be moved three-dimensionally, printing can be performed on various workpieces, but ensuring a movable region of the head unit is a problem.

### SUMMARY

According to an aspect of the present disclosure, a three-dimensional object printing apparatus includes: a first head unit including a first head that discharges liquid; and a robot that moves the first head unit with respect to a workpiece in a state in which the first head unit is mounted on the robot, in which the first head unit includes a coupling portion that is coupled to a distal end of the robot, the first head includes a nozzle surface provided with a nozzle that discharges the liquid, the nozzle surface is positioned at a lower end of the first head unit in a first direction perpendicular to the nozzle surface, and an upper end of the coupling portion is positioned between an upper end and the lower end of the first head unit in the first direction.

According to another aspect of the present disclosure, a head unit including an upper end and a lower end includes: a head that discharges liquid; and a coupling portion configured to be coupled to a distal end of a robot, in which the head includes a nozzle surface provided with a nozzle that discharges the liquid, the nozzle surface is positioned at the lower end in a first direction perpendicular to the nozzle surface, and an upper surface of the coupling portion is positioned between the upper end and the lower end in the first direction.

### BRIEF DESCRIPTION OF THE DRAWINGS

FIG. 1 is a perspective view showing an outline of a three-dimensional object printing apparatus according to an embodiment of the present disclosure.

FIG. 2 is a block diagram showing an electrical configuration of the three-dimensional object printing apparatus according to the present embodiment.

FIG. 3 is an explanatory diagram for describing a schematic structure of a head unit.

FIG. 4 is an explanatory diagram for describing an operation for opening a self-sealing valve.

FIG. 5 is an explanatory diagram for describing the head unit mounted on a robot.

FIG. 6 is an explanatory diagram for describing a backflow prevention mechanism for ink.

FIG. 7 is an explanatory diagram for describing a head unit according to a first modification example.

FIG. 8 is an explanatory diagram for describing a head unit according to a second modification example.

FIG. 9 is an explanatory diagram for describing another example of an operation for opening the self-sealing valve.

### DESCRIPTION OF EMBODIMENTS

An embodiment for carrying out the present disclosure will be described below with reference to the drawings. However, in each drawing, the dimensions and scales of each part are appropriately different from those of the actual ones. In addition, since the embodiment described below is a suitable specific example of the present disclosure, various technically preferable limitations are added, but the scope of the present disclosure is not limited to these embodiments unless otherwise stated in the following description to particularly limit the present disclosure.

In the following, for convenience of description, an X-axis, a Y-axis, and a Z-axis that intersect with each other are appropriately used. In addition, hereinafter, one direction along the X-axis is an X1 direction, and a direction opposite to the X1 direction is an X2 direction. In the same manner, directions opposite to each other along the Y-axis are a Y1 direction and a Y2 direction. In addition, directions opposite to each other along the Z-axis are a Z1 direction and a Z2 direction.

Here, the X-axis, the Y-axis, and the Z-axis correspond to coordinate axes of a world coordinate system set in a space in which a robot 2, which will be described below, is installed. Typically, the Z-axis is a vertical axis, and the Z2 direction corresponds to a downward direction in a vertical direction. A base coordinate system with reference to a position of a base portion 210, which will be described below, of the robot 2 is associated with the world coordinate system via calibration. In the following, for convenience, a case where an operation of the robot 2 is controlled by using the world coordinate system as a robot coordinate system will be exemplified.

The Z-axis may not be the vertical axis. Further, the X-axis, the Y-axis, and the Z-axis are typically orthogonal to each other, but the present disclosure is not limited to this, and the X-axis, the Y-axis, and the Z-axis may not be orthogonal to each other. For example, the X-axis, Y-axis, and Z-axis need only intersect with each other at an angle within a range of 80° or more and 100° or less.

### 1. Embodiment

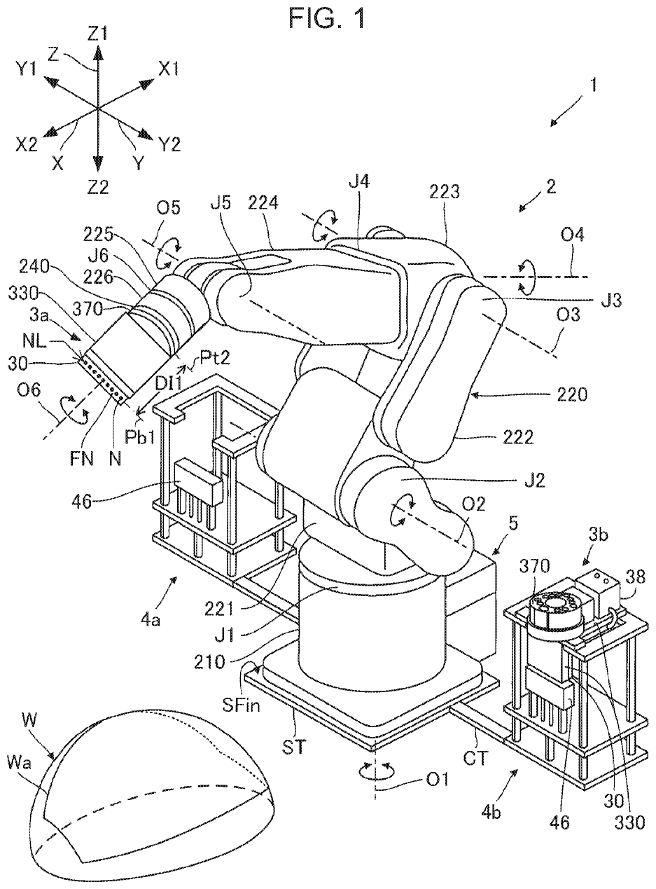

First, an outline of a three-dimensional object printing apparatus 1 according to the present embodiment will be described with reference to FIG. 1.

FIG. 1 is a perspective view showing an outline of the three-dimensional object printing apparatus 1 according to the embodiment of the present disclosure. The three-dimensional object printing apparatus 1 is an apparatus that performs printing on a printing region Wa which is a partial region or an entire region of a surface of a three-dimensional workpiece W via an ink jet method.

The workpiece W has a surface including the printing region Wa, which is a range in which an image is formed. In an example shown in FIG. 1, the workpiece W is a hemispherical body, and the surface of the workpiece W is a protruding hemispherical surface. The workpiece W is supported by, for example, a predetermined installation table, a hand of a robot other than the robot 2, or a structure such as a conveyor. A size, a shape, or an installation posture of the workpiece W is not limited to the example shown in FIG. 1, and is selected in any manner.

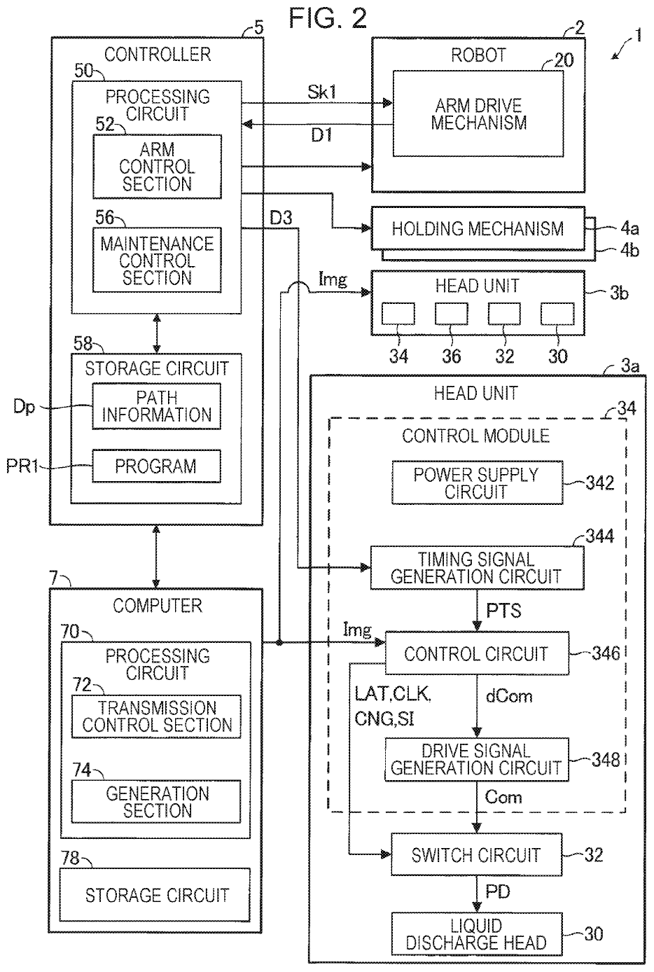

The three-dimensional object printing apparatus 1 shown in FIG. 1 includes the robot 2, head units 3a and 3b, holding mechanisms 4a and 4b used as places respectively for the head units 3a and 3b, a controller 5 that controls the operation of the robot 2, a pedestal ST, and a coupling member CT. Further, the three-dimensional object printing apparatus 1 includes a computer 7 described in FIG. 2.

In the example shown in FIG. 1, the head unit 3a is mounted on the robot 2, and the head unit 3b is held by the holding mechanism 4b. In the following, the head units 3a and 3b may be collectively referred to as a head unit 3, and the holding mechanisms 4a and 4b may be collectively referred to as a holding mechanism 4. In addition, in FIG. 1, a case where the number of head units 3 included in the three-dimensional object printing apparatus 1 is two is exemplified, but the number of head units 3 is not limited to two. For example, the number of head units 3 included in the three-dimensional object printing apparatus 1 may be one or three or more. Similarly, the number of holding mechanisms 4 included in the three-dimensional object printing apparatus 1 is not limited to two, and may be one or three or more. In addition, for example, when the number of head units 3 included in the three-dimensional object printing apparatus 1 is one, the three-dimensional object printing apparatus 1 need not include the holding mechanism 4. The number of holding mechanisms 4 included in the three-dimensional object printing apparatus 1 is preferably the same as the number of head units 3 provided in the three-dimensional object printing apparatus 1. One of the head units 3a and 3b is an example of a “first head unit”, and the other of the head units 3a and 3b is an example of a “second head unit”.

First, the robot 2 will be described.

The robot 2 changes a position and posture of the head unit 3 in the world coordinate system. For example, the robot 2 moves the head unit 3 while changing the posture of the head unit 3 with respect to the three-dimensional workpiece W. In the example shown in FIG. 1, the robot 2 is a so-called six-axis vertical articulated robot.

As shown in FIG. 1, the robot 2 includes the base portion 210, an arm 220, joints J1 to J6, and a tool changer 240. Further, the robot 2 includes an arm drive mechanism 20 and the like described in FIG. 2. In the following, the joints J1 to J6 may be collectively referred to as a joint J, and rotational axes O1 to O6 described below may be collectively referred to as a rotational axis O.

The base portion 210 is a base that supports the arm 220. In the example shown in FIG. 1, the base portion 210 is fixed to an installation surface SFin of the pedestal ST by screwing or the like. The installation surface SFin on which the base portion 210 is fixed is, for example, a surface of the pedestal ST facing the Z1 direction. The installation surface SFin on which the base portion 210 is fixed is not limited to the installation surface SFin of the pedestal ST, and may be a surface of a floor, a wall, a ceiling, or a movable trolley. That is, the installation surface SFin on which the base portion 210 is fixed may face any direction.

The arm 220 is coupled to the base portion 210 and the head unit 3, and changes the position and posture of the head unit 3 with respect to the workpiece W. In the example shown in FIG. 1, the arm 220 is a six-axis robot arm that three-dimensionally changes the position and posture of the head unit 3 with respect to the base portion 210. Specifically, the arm 220 includes arms 221, 222, 223, 224, 225, and 226, which are coupled in this order.

The arms 221 to 226 are coupled to each other via the joints J1 to J6 to be rotatable about the rotational axes O1 to O6.

As described above, the arm 225 is coupled to the arm 226. For example, the coupling of the members includes both a case where two members are directly coupled to each other and a case where two members are indirectly coupled to each other. The direct coupling of the two members includes a state where the two members are in contact with each other and a state that can be regarded as the state where the two members are in contact with each other. The state that can be regarded as the state where the two members are in contact with each other is, for example, a state where one of the two members is fixed to the other member by an adhesive or the like. In addition, the indirect coupling of the two members means that another member is disposed between the two members. The arm 226 is an example of a “first arm”, and the rotational axis O6 is an example of a “first rotational axis”. In addition, the arm 225 is an example of a “second arm”, and the rotational axis O5 is an example of a “second rotational axis”.

Each of the joints J1 to J6 is a mechanism for rotatably coupling one of two adjacent members among the base portion 210 and the arms 221 to 226 to the other.

Although not shown in FIG. 1, each joint J is provided with a drive mechanism that causes one of the two members coupled via the joint J to rotate with respect to the other. A set of the drive mechanisms of the joints J1 to J6 corresponds to the arm drive mechanism 20 shown in FIG. 2, which will be described below.

The rotational axis O1 is an axis perpendicular to the installation surface SFin to which the base portion 210 is fixed. The rotational axis O2 is an axis perpendicular to the rotational axis O1. The rotational axis O3 is an axis parallel with the rotational axis O2. The rotational axis O4 is an axis perpendicular to the rotational axis O3. The rotational axis O5 is an axis perpendicular to the rotational axis O4. The rotational axis O6 is an axis perpendicular to the rotational axis O5.

Regarding these rotational axes, “perpendicular” includes not only a case where an angle formed by two rotational axes is strictly 90°, but also a case where the angle formed by the two rotational axes deviates within a range of approximately 90° to +5°. Similarly, “parallel” includes not only a case where two rotational axes are strictly parallel with each other, but also a case where one of the two rotational axes is inclined within a range of approximately +5° with respect to the other. In addition, orientations of these rotational axes are not limited to the example shown in FIG. 1.

Among the arms 221 to 226 of the robot 2, the arm 226 positioned at a distal end of the robot 2 is equipped with the head unit 3 as an end effector. In the example shown in FIG. 1, the head unit 3a is mounted on the arm 226 by the tool changer 240 and a tool changer 370. The tool changer 370 is an example of a “coupling portion”.

Next, an outline of the head unit 3 will be described. Since a configuration of the head unit 3a is the same as a configuration of the head unit 3b, the following description relating to the head unit 3 will apply to both head units 3a and 3b unless otherwise specified. Details of the head unit 3 will be described in FIG. 2 and subsequent figures.

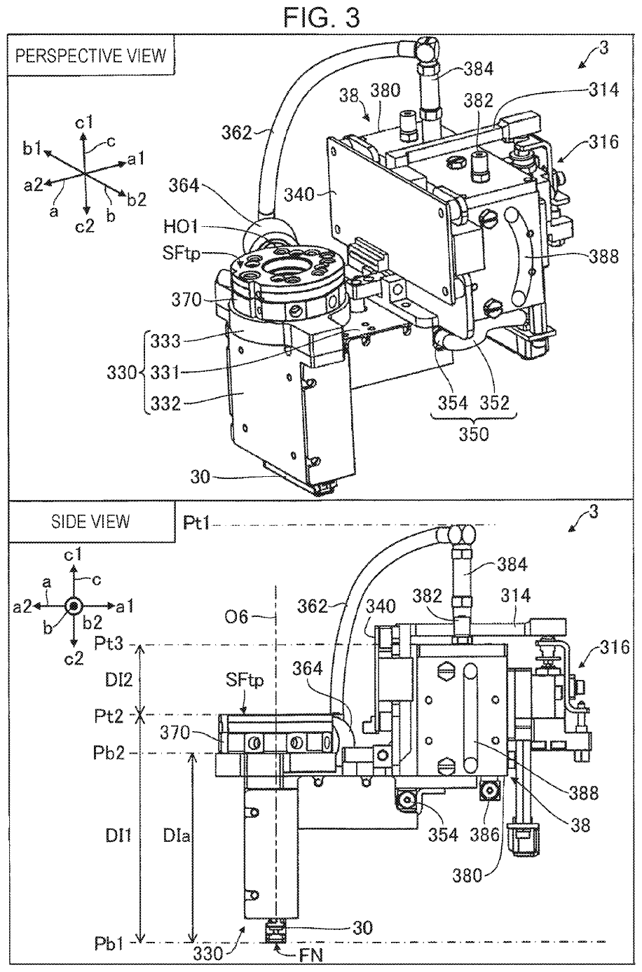

The head unit 3 is an assembly that includes a liquid discharge head 30 that discharges ink toward the workpiece W. For example, the head unit 3 includes the liquid discharge head 30, an ink tank 38 in which ink is stored, a support body 330 that supports the liquid discharge head 30, the ink tank 38, and the like, and the tool changer 370 that is coupled to the tool changer 240 of the robot 2. Further, the head unit 3 includes a switch circuit 32 and a control module 34 described in FIG. 2 and the like. In addition, the head unit 3 further includes components such as a self-sealing unit 310, a wiring member 320, and a pipe portion 350 described in FIG. 3. The liquid discharge head 30 is an example of a “head”, a “first head”, or a “second head”, and the ink is an example of a “liquid”.

The liquid discharge head 30 includes, for example, a nozzle surface FN and a nozzle row NL in which a plurality of nozzles N that are open to the nozzle surface FN are disposed to extend in a predetermined direction in a row. Although not shown, the liquid discharge head 30 has a piezoelectric element, which is a drive element, and a cavity that accommodates the ink, for each nozzle N. As a drive element for discharging ink from the nozzle N, a heater that heats ink in the cavity may be used, instead of the piezoelectric element.

In the example shown in FIG. 1, the liquid discharge head 30 includes one nozzle row NL, but the liquid discharge head 30 may include a plurality of nozzle rows NL. It is preferable that, regardless of the number of nozzle rows NL included in the liquid discharge head 30, as ink discharged from the plurality of nozzles N included in the liquid discharge head 30, the same type of ink is used by the plurality of nozzles N.

The ink is not particularly limited, and examples thereof include an aqueous ink in which a coloring material such as a dye or a pigment is dissolved in an aqueous solvent, a curable ink using a curable resin such as an ultraviolet curable type resin, a solvent-based ink in which a coloring material such as a dye or a pigment is dissolved in an organic solvent, and the like. The curable ink is not particularly limited, and examples thereof include ink of a thermosetting type, a photocuring type, a radiation-curing type, and an electron beam curing type.

Here, for example, when the three-dimensional object printing apparatus 1 performs printing using ink in a plurality of colors, ink in different colors is used in the head unit 3a and the head unit 3b. Hereinafter, the ink used in the head unit 3a may be referred to as first color ink, and the ink used in the head unit 3b may be referred to as second color ink. For example, when the first color ink is discharged onto the workpiece W, the robot 2 moves the head unit 3a with respect to the workpiece W in a state in which the head unit 3a is mounted. As a result, printing with the first color ink is executed on the workpiece W. In addition, when the second color ink is discharged onto the workpiece W, the robot 2 disposes the head unit 3a in the holding mechanism 4a and remove the head unit 3a from the arm 226, and mount the head unit 3b held by the holding mechanism 4b on the arm 226. Then, the robot 2 moves the head unit 3b with respect to the workpiece W in a state in which the head unit 3b is mounted. As a result, printing with the second color ink is executed on the workpiece W. As described above, in the present embodiment, printing using ink in a plurality of colors can be executed by replacing the head unit 3 for each color. As a result, in the present embodiment, the enlargement of the liquid discharge head 30 itself can be suppressed as compared with a configuration in which one liquid discharge head discharges ink in a plurality of colors. That is, in the present embodiment, the liquid discharge head 30 can be downsized as compared with the configuration in which one liquid discharge head discharges ink in a plurality of colors.

In addition, in the present embodiment, in the printing in which liquid droplets having different sizes are discharged, a size of a liquid droplet of ink discharged from the liquid discharge head 30 of the head unit 3a and a size of a liquid droplet of ink discharged from the liquid discharge head 30 of the head unit 3b may be made different from each other. In this case as well, the liquid discharge head 30 can be more downsized as compared with a configuration in which the printing in which liquid droplets having different sizes are discharged is performed by one liquid discharge head. As described above, in the present embodiment, since the head unit 3 can be replaced for each color of the ink or each type of the ink, the convenience of a user can be improved.

It should be noted that, in the present embodiment, a case is assumed in which the robot 2 itself automatically executes replacement of the head unit 3 under control of the controller 5. For example, the controller 5 determines whether the printing on the workpiece W using the ink discharged from the head unit 3a is completed, based on path information Dp, print data Img, and the like shown in FIG. 2 described below. Then, when the printing is completed, the controller 5 replaces the head unit 3 mounted on the robot 2 from the head unit 3a to the head unit 3b. As described above, the head units 3a and 3b are automatically attached to and detached from the robot 2. A timing of replacing the head unit 3 may be determined by the user. In this case, for example, the user operates the controller 5 at the timing of replacing the head unit 3 to cause the controller 5 to execute the control for exchanging the head unit 3.

In addition, in the present embodiment, the holding mechanism 4a is disposed at a position in the Y1 direction with respect to the pedestal ST on which the base portion 210 of the robot 2 is installed, and the holding mechanism 4b is disposed at a position in the Y2 direction with respect to the pedestal ST. That is, in the present embodiment, the robot 2 is positioned between the holding mechanism 4a and the holding mechanism 4b, when the robot 2 is viewed in the X1 direction which is a direction parallel to the installation surface SFin on which the robot 2 is installed and which is a direction facing the robot 2 from a place where the workpiece W is disposed. Therefore, in the present embodiment, a movement amount of the robot 2 when the head unit 3 is mounted on the robot 2 can be prevented from being increased by the head unit 3 mounted on the robot 2.

In addition, in the present embodiment, the holding mechanisms 4a and 4b are coupled to the pedestal ST by the coupling member CT. It is preferable that a material of the coupling member CT is, for example, a rigid body such as a metal material. Since the holding mechanisms 4a and 4b are coupled to the pedestal ST by the coupling member CT, the positions of the holding mechanisms 4a and 4b with respect to the robot 2 are uniquely determined. As a result, in the present embodiment, when the head unit 3 mounted on the robot 2 is replaced, the three-dimensional object printing apparatus 1 can easily specify the position of the holding mechanism 4. As a result, in the present embodiment, the head unit 3 can be easily replaced. The holding mechanisms 4a and 4b may be disposed at any position within a movement range of the arm 226 without being coupled to the pedestal ST. In this case, for example, the position of the holding mechanism 4 with respect to the robot 2 may be set in the controller 5 or the like after the holding mechanism 4 is disposed. The setting of the position of the holding mechanism 4 with respect to the robot 2 may be implemented by instructing an operation of disposing the head unit 3 mounted on the arm 226 in the holding mechanism 4. Alternatively, the controller 5 may specify the position of the holding mechanism 4 with respect to the robot 2 and store the specified position by controlling the operation of the robot 2 such that the head unit 3 mounted on the arm 226 is disposed in the holding mechanism 4 in cooperation with an imaging device such as a camera that images the distal end of the robot 2. Even in a configuration where the holding mechanism 4 is not coupled to the pedestal ST, the position of the holding mechanism 4 with respect to the robot 2 is set in the controller 5 or the like, causing the position of the holding mechanism 4 to be easily specified when replacing the head unit 3 mounted on the robot 2.

In addition, in the present embodiment, a maintenance unit 46 that maintains the liquid discharge head 30 is provided in the holding mechanism 4. The maintenance unit 46 may be regarded as a part of the elements included in the holding mechanism 4, or may be regarded as an element separate from the holding mechanism 4. The maintenance unit 46 includes, for example, a cap that covers the liquid discharge head 30 such that the nozzle N is sealed. In addition, the maintenance unit 46 may include an ejected ink receiving portion for receiving ink ejected by a flushing process of ejecting the ink in the liquid discharge head 30. In addition, the maintenance unit 46 may include one or both of a wiper used for a wiping process of wiping off foreign matter such as paper dust adhering to the vicinity of the nozzle N and a tube pump used for a pumping process of sucking ink, air bubbles, or the like in the liquid discharge head 30. The maintenance includes, for example, at least one of protection of the liquid discharge head 30 via the cap, the flushing process, the wiping process, or the pumping process.

For example, the maintenance unit 46 provided in the holding mechanism 4a performs maintenance on the liquid discharge head 30 of the head unit 3a in a state in which the head unit 3a is held by the holding mechanism 4a, that is, in a state in which the head unit 3a is not mounted on the robot 2. Similarly, the maintenance unit 46 provided in the holding mechanism 4b performs maintenance on the liquid discharge head 30 of the head unit 3b in a state in which the head unit 3b is held by the holding mechanism 4b, that is, in a state in which the head unit 3b is not mounted on the robot 2. As a result, in the present embodiment, the maintenance of the liquid discharge head 30 of each head unit 3 can be efficiently executed.

Here, a movable region of the three-dimensional object printing apparatus 1, that is, a movable region of the head unit 3 depends on a movable region of the robot 2 and the size of the head unit 3. From the viewpoint of the movable region of the robot 2, when the arm 220 is extended until vibration of a distal end of the arm 220 is difficult to be attenuated, that is, when an extension amount of the arm 220 is large, it is difficult to ensure a printing quality. Meanwhile, when the extension amount of the arm 220 is small, an amount of rotation of the arm 220 about the rotational axis O changes abruptly, and it is difficult to ensure the printing quality. Therefore, a printing region in which the printing quality can be ensured is limited. In addition, from the viewpoint of the size of the head unit 3, the larger the head unit 3 is, the narrower a printable range is.

For example, the longer a distance D1 from an upper end Pt2 of the tool changer 370 to a lower end Pb1 of the head unit 3 is, the narrower the printable range is. For example, in the head unit 3 in which the distance DI1 is long, the vibration of the head unit 3 when the extension amount of the arm 220 is large is difficult to be attenuated as compared with the head unit 3 in which the distance DI1 is short. In addition, in the head unit 3 in which the distance DI1 is long, the arm 220 is likely to interfere with the head unit 3 when the arm 220 is contracted as compared with the head unit 3 in which the distance DI1 is short, so that the movable region of the head unit 3 when the arm 220 is contracted is narrowed, and the printable range is narrowed. Therefore, in the present embodiment, the movable region of the three-dimensional object printing apparatus 1, that is, the movable region of the head unit 3 is secured by downsizing the head unit 3. For example, in the present embodiment, as will be described in FIG. 3 and subsequent figures, the head unit 3 is downsized such that the distance DI1 from the upper end Pt2 of the tool changer 370 to the lower end Pb1 of the head unit 3 is shortened.

Next, an electrical configuration of the three-dimensional object printing apparatus 1 will be described with reference to FIG. 2, including a detailed description of the controller 5.

FIG. 2 is a block diagram showing the electrical configuration of the three-dimensional object printing apparatus 1 according to the present embodiment. In FIG. 2, among components of the three-dimensional object printing apparatus 1, electrical components are shown. As shown in FIG. 2, the three-dimensional object printing apparatus 1 includes a computer 7 that is communicably connected to the controller 5, in addition to the components shown in FIG. 1.

Each electrical component shown in FIG. 2 may be appropriately divided, a part thereof may be included in another component, or may be integrally formed with the other component. For example, a part or all of the functions of the controller 5 may be implemented by the computer 7, or may be implemented by another external device such as a personal computer (PC) connected to the controller 5 via a local area network (LAN), the Internet, or the like. In addition, the computer 7 may be regarded as an external element of the three-dimensional object printing apparatus 1.

The controller 5 has a function of controlling the operation of the robot 2 and a function of generating a signal D3 for synchronizing an ink discharge operation in the head unit 3 with the operation of the robot 2. For example, the controller 5 includes a processing circuit 50 and a storage circuit 58.

The storage circuit 58 stores various programs executed by the processing circuit 50, various kinds of data processed by the processing circuit 50, and the like. The storage circuit 58 includes, for example, one or both semiconductor memories of a volatile memory such as a random-access memory (RAM) and a non-volatile memory such as a read-only memory (ROM), an electrically erasable programmable read-only memory (EEPROM), or a programmable ROM (PROM). A part or all of the storage circuit 58 may be included in the processing circuit 50.

In the present embodiment, the storage circuit 58 stores a program PR1 and the path information Dp. The program PR1 is, for example, a program that causes the controller 5 to control the operation of the robot 2. The path information Dp is used to control the operation of the robot 2 and indicates the position and posture of the liquid discharge head 30 in a path along which the liquid discharge head 30 is to be moved during the execution of the printing operation. The position and posture of the liquid discharge head 30 are defined, for example, with reference to a tool center point of the robot 2.

The processing circuit 50 includes, for example, one or more processors such as a central processing unit (CPU). The processing circuit 50 may include a programmable logic device such as a field-programmable gate array (FPGA) instead of the CPU or in addition to the CPU. The processing circuit 50 functions as an element that controls the operation of the robot 2 or the like by, for example, executing the program PR1 stored in the storage circuit 58 and operating in accordance with the program PR1. Specifically, the processing circuit 50 operates in accordance with the program PR1 to function as an arm control section 52 and a maintenance control section 56 that controls the operation of the maintenance unit 46 included in the holding mechanism 4.

Here, the arm drive mechanism 20 is the set of the drive mechanisms of the joints J1 to J6 described in FIG. 1, and includes, for each joint J, a motor for driving the joint J of the robot 2 and an encoder for measuring a rotation angle of the joint J of the robot 2.

The arm control section 52 performs inverse kinematics calculation, which is a calculation of converting the path information Dp into operation amounts such as the rotation angle and rotation speed of each joint J of the robot 2. In addition, the arm control section 52 acquires, as a signal D1 output from each encoder of the arm drive mechanism 20, a signal based on a measurement result of the rotation angle of the joint J corresponding to the encoder. Then, the arm control section 52 outputs a control signal Sk1 based on the signal D1 output from each encoder such that the operation amount of each joint J, such as the actual rotation angle and rotation speed, matches the result of the inverse kinematics calculation based on the path information Dp. The control signal Sk1 is a signal for controlling an operation of the motor of the arm drive mechanism 20.

In addition, the arm control section 52 generates the signal D3 based on the signal D1 output from at least one of a plurality of the encoders included in the arm drive mechanism 20. The signal D3 is transmitted from the controller 5 to the head unit 3a mounted on the robot 2 among the head units 3a and 3b.

The head unit 3 includes the switch circuit 32 and the control module 34 in addition to the liquid discharge head 30 shown in FIG. 1. A drive signal generation circuit 348 is an example of a “first drive circuit”. The control module 34 may be regarded as the “first drive circuit”.

The control module 34 is a circuit that controls the ink discharge operation in the liquid discharge head 30 based on the signal D3 output from the controller 5 and the print data Img from the computer 7. The print data Img is information indicating an image to be printed on the workpiece W in each path of a plurality of paths indicated by the path information Dp. The control module 34 includes a power supply circuit 342, a timing signal generation circuit 344, a control circuit 346, and the drive signal generation circuit 348.

The power supply circuit 342 receives power supply from a commercial power supply (not shown) and generates various potentials such as a power supply potential. Then, the power supply circuit 342 appropriately supplies the generated various potentials to each unit of the switch circuit 32 and the control module 34.

The timing signal generation circuit 344 generates a timing signal PTS based on the signal D3.

The control circuit 346 generates, for example, a control signal SI, a waveform designation signal dCom, a latch signal LAT, a clock signal CLK, and a change signal CNG. Then, the control circuit 346 outputs the control signal SI, the latch signal LAT, the clock signal CLK, and the change signal CNG to the switch circuit 32 in synchronization with the timing signal PTS, and outputs the waveform designation signal dCom to the drive signal generation circuit 348.

The control signal SI is a digital signal for designating an operation state of each drive element included in the liquid discharge head 30. The waveform designation signal dCom is a digital signal for defining a waveform of the drive signal Com. The latch signal LAT and the change signal CNG are signals for defining a discharge timing of the ink from the nozzle corresponding to each drive element. The clock signal CLK is a reference clock signal synchronized with the timing signal PTS.

Here, the control circuit 346 includes, for example, one or more processors such as CPUs. The control circuit 346 may include a programmable logic device such as an FPGA instead of or in addition to the CPU.

The drive signal generation circuit 348 is a circuit that generates the drive signal Com for driving each drive element included in the liquid discharge head 30.

Here, the switch circuit 32 is a circuit including a switching element that switches whether to supply at least some of the waveforms included in the drive signal Com as a drive pulse PD based on the control signal SI.

The computer 7 has a function of generating the path information Dp, a function of supplying information such as the path information Dp to the controller 5, and a function of supplying information such as the print data Img to the control module 34. For example, the computer 7 includes a processing circuit 70 configured in the same manner as the processing circuit 50 of the controller 5 described above, and a storage circuit 78 configured in the same manner as the storage circuit 58 of the controller 5. The processing circuit 70 functions as a transmission control section 72 and a generation section 74 by operating in accordance with a program (not shown) stored in the storage circuit 78, for example. For example, the generation section 74 generates the path information Dp based on workpiece information indicating the position and shape of the workpiece W, and supplies the generated path information Dp to the controller 5.

In addition, for example, the transmission control section 72 transmits the print data Img to the control circuit 346 of the head unit 3a mounted on the robot 2 and to the control circuit 346 of the head unit 3b held by the holding mechanism 4b. That is, the transmission control section 72 transmits the print data Img to the control module 34 of the head unit 3b even in a state in which the head unit 3b is not mounted on the robot 2. When the head unit 3a is mounted on the robot 2, the control module 34 of the head unit 3b supplies the drive signal Com to the liquid discharge head 30 of the head unit 3b based on the print data Img at a timing based on a detection timing of the signal D3. The transmission control section 72 transmits the print data Img to the control circuit 346 via wired or wireless communication.

The computer 7 is, for example, a PC. In addition, the computer 7 may have a function as a user interface for the three-dimensional object printing apparatus 1. For example, the computer 7 may have an input device, such as a keyboard or a mouse, that receives operations from the user, or may have a display device, such as a liquid crystal panel, that displays information necessary for the generation of the path information Dp.

As described above, in the present embodiment, the operation of the robot 2 is controlled based on the path information Dp, and the operation of the liquid discharge head 30 of the head unit 3a mounted on the robot 2 is controlled based on the print data Img and the signal D3, whereby the printing operation is performed. For example, in the printing operation, the robot 2 changes the position and posture of the liquid discharge head 30 based on the path information Dp, and the liquid discharge head 30 is caused to discharge ink from the liquid discharge head 30 toward the workpiece W at an appropriate timing based on the print data Img and the signal D3. Thus, an image based on the print data Img is formed at the workpiece W.

Next, a schematic structure of the head unit 3 will be described with reference to FIG. 3.

FIG. 3 is an explanatory diagram for describing the schematic structure of the head unit 3. The upper part of FIG. 3 is a perspective view of the head unit 3, and the lower part of FIG. 3 is a side view of the head unit 3 as viewed from a b2 direction described below.

Hereinafter, for convenience of description, an a-axis, a b-axis, and a c-axis intersecting each other will be used as appropriate for description. In addition, in the following, one direction along the a-axis is an a1 direction, and a direction opposite to the a1 direction is an a2 direction. Similarly, directions opposite to each other along the b axis are a b1 direction and the b2 direction. In addition, directions opposite to each other along the c axis are a c1 direction and a c2 direction. In the present embodiment, the a axis and the b axis are axes parallel to the nozzle surface FN, and the c axis is an axis perpendicular to the nozzle surface FN. The term “perpendicular” includes not only strict perpendicularity but also substantial perpendicularity. Similarly, the term “parallel” includes not only strict parallelism but also substantial parallelism. The c1 direction is an example of a “first direction”, and the a2 direction is an example of a “second direction”. In addition, hereinafter, unless otherwise specified, in the c1 direction, an upper side means the c1 direction, and a lower side means the c2 direction opposite to the c1 direction. In addition, hereinafter, unless otherwise specified, an upper end of each element included in the head unit 3 means an end part of each element in the c1 direction, and a lower end of each element included in the head unit 3 means an end part of each element in the c2 direction.

Here, the a axis, the b axis, and the c axis correspond to coordinate axes of a tool coordinate system set in the head unit 3, and a relationship between the relative position and the posture with respect to the world coordinate system or the robot coordinate system is changed by the operation of the robot 2. In an example shown in FIG. 3, when the head unit 3 is mounted on the robot 2, the c-axis is an axis parallel to the rotational axis O6 described in FIG. 1. The a-axis, the b-axis, and the c-axis are typically orthogonal to each other, but the present disclosure is not limited to this, and the a-axis, the b-axis, and the c-axis need only intersect with each other at an angle within a range of 80° or more and 100° or less, for example. The tool coordinate system, and the base coordinate system or the robot coordinate system are associated with each other by calibration.

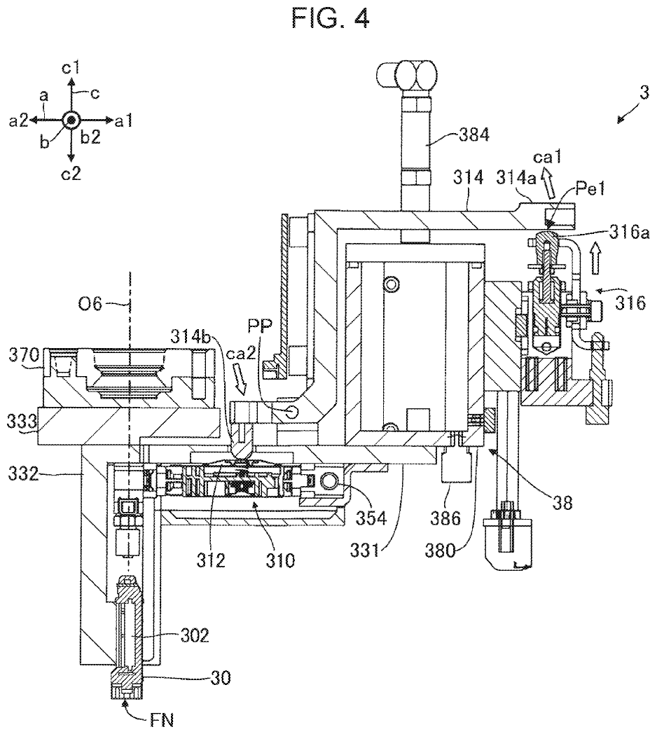

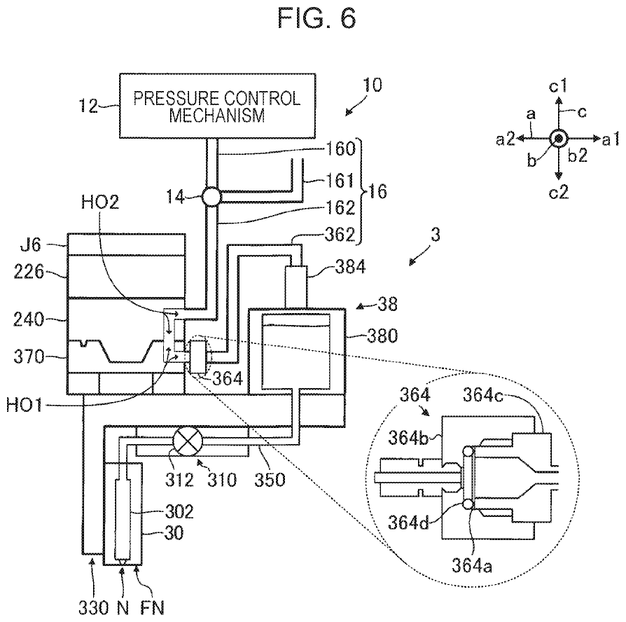

The head unit 3 includes the liquid discharge head 30, the ink tank 38, the support body 330, a lever 314, a valve opening and closing mechanism 316, a drive substrate 340, the pipe portion 350, a tube 362, a backflow prevention mechanism 364, and the tool changer 370. Further, the head unit 3 includes the self-sealing unit 310 and the like described in FIG. 4. The control module 34 is mounted on the drive substrate 340, and the wiring member 320 described in FIG. 4 is connected to the drive substrate 340. The backflow prevention mechanism 364 is attached to the tool changer 370, and the backflow prevention mechanism 364 is coupled to an opening portion HO1 of the tool changer 370. The opening portion HO1 is a so-called air port through which air passes, the backflow prevention mechanism 364 is attached to one end, and the other end communicates with an opening portion HO2 of the tool changer 240 shown in FIG. 6. The backflow prevention mechanism 364 will be described in FIG. 6. In addition, the self-sealing unit 310, the lever 314, and the valve opening and closing mechanism 316 will be described in FIG. 4. The drive substrate 340 is an example of a “first drive substrate”.

For example, the liquid discharge head 30, the ink tank 38, the drive substrate 340, and the tool changer 370 are attached to the support body 330.

For example, the support body 330 includes a first support portion 331 having a surface facing the c1 direction and a surface facing the c2 direction, a second support portion 332 having a surface facing the a2 direction and a surface facing the a1 direction, and a third support portion 333. The first support portion 331 is provided to protrude in the a1 direction from the second support portion 332. The ink tank 38 and the drive substrate 340 are attached to the surface of the first support portion 331 facing the c1 direction. In addition, the liquid discharge head 30 is attached to a surface of the second support portion 332 that is near an end part in the c2 direction and faces the a1 direction. In addition, the first support portion 331 and the second support portion 332 are coupled to the tool changer 370 via the third support portion 333. For example, the third support portion 333 is coupled to the tool changer 370 and is coupled to the first support portion 331 and the second support portion 332.

In the present embodiment, for example, the liquid discharge head 30 is positioned below the tool changer 370 in the c1 direction and overlaps the rotational axis O6 as viewed from the c1 direction. In addition, the nozzle surface FN of the liquid discharge head 30 is positioned at the lower end Pb1 of the head unit 3 in the c1 direction. That is, a lower end of the liquid discharge head 30 corresponds to the lower end Pb1 of the head unit 3. In the present embodiment, since the liquid discharge head 30 is provided on the rotational axis O6, the influence of the vibration of the robot 2 during printing on the liquid discharge head 30 can be suppressed.

In addition, the ink tank 38 includes a tank portion 380 that stores the ink, a supply port 382 for supplying the ink to the tank portion 380, a ventilation port 384 for taking in air for adjusting a pressure inside the tank portion 380, and an ejection port 386 for ejecting the ink from the tank portion 380. In addition, in the present embodiment, the ink tank 38 includes a transparent tube 388 for visually recognizing a remaining amount of the ink in the tank portion 380. For example, one end of the tube 388 is attached near an upper end of the tank portion 380 to communicate with the inside of the tank portion 380 of the ink tank 38, and the other end of the tube 388 is attached near a lower end of the tank portion 380 to communicate with the inside of the tank portion 380. As a result, in the present embodiment, for example, the user can visually recognize the remaining amount of the ink in the tank portion 380 by visually recognizing the ink remaining in the tube 388. The ink tank 38 need not include the tube 388. In this case, the head unit 3 may include a sensor or the like that detects the remaining amount of the ink in the tank portion 380. The tank portion 380 of the ink tank 38 is an example of a “storage section”. The ink tank 38 may be regarded as the “storage section”.

The ink is supplied from the tank portion 380 of the ink tank 38 to the liquid discharge head 30 via the pipe portion 350. The pipe portion 350 is a member that couples the liquid discharge head 30 and the ink tank 38, and includes a tube 352 and a coupling portion 354. For example, the tube 352 couples the ejection port 386 and the coupling portion 354. In addition, the coupling portion 354 communicates with the self-sealing unit 310 shown in FIG. 4. As a result, the ink tank 38 is coupled to the self-sealing unit 310. In the side view of FIG. 4, the tube 352 is not shown.

In a state in which the ink is not supplied to the tank portion 380 of the ink tank 38, the supply port 382 may be covered with a lid so that the ink does not leak from the tank portion 380. Alternatively, the supply port 382 may be formed with a small opening part to prevent ink from leaking from the ink tank 38.

In addition, the tank portion 380 of the ink tank 38 is positioned in the a1 direction with respect to the tool changer 370. That is, the tool changer 370 is positioned in the a2 direction with respect to the tank portion 380 of the ink tank 38. In addition, the tool changer 370 overlaps the tank portion 380 of the ink tank 38 as viewed from the a2 direction. That is, the tank portion 380 of the ink tank 38 is provided at a position that does not overlap the tool changer 370 as viewed from the c1 direction and that overlaps the tool changer 370 as viewed from the a2 direction. As a result, in the present embodiment, a distance DIa between the lower end Pb1 of the head unit 3 and a lower end Pb2 of the tool changer 370 can be shortened as compared with a first proportion in which the tank portion 380 is provided at a position that overlaps the tool changer 370 as viewed from the c1 direction. Therefore, in the present embodiment, the movable region of the head unit 3 can be secured as compared with the first proportion.

In addition, in the present embodiment, for example, as shown in the side view of FIG. 3, an upper end of the ink tank 38 corresponds to an upper end Pt1 of the head unit 3. In the example shown in FIG. 3, an end part of the ventilation port 384 in the c1 direction corresponds to the upper end Pt1 of the head unit 3. An upper end Pt3 of the tank portion 380, which is a main body of the ink tank 38, may be the upper end Pt1 of the head unit 3.

When a positional relationship between the upper end Pt1 and the lower end Pb1 of the head unit 3 and the tool changer 370 is focused on, in the c1 direction, the upper end Pt2 of the tool changer 370 is positioned between the upper end Pt1 and the lower end Pb1 of the head unit 3. Therefore, in the present embodiment, the distance DI1 between the upper end Pt2 of the tool changer 370 and the lower end Pb1 of the head unit 3 can be shortened as compared with a second proportion in which the upper end Pt2 of the tool changer 370 is positioned at the upper end Pt1 of the head unit 3. As a result, in the present embodiment, the movable region of the head unit 3 can be secured. An upper surface SFtp of the tool changer 370 corresponds to the upper end Pt2 of the tool changer 370.

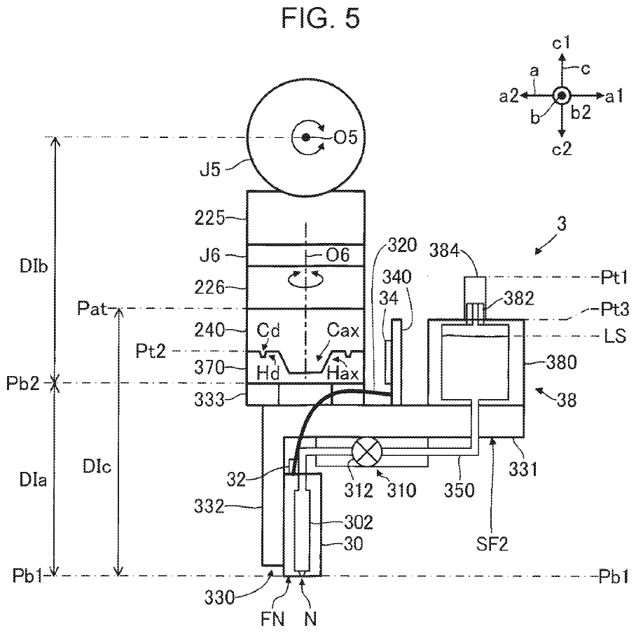

In addition, when the distance DI1 along the c1 direction between the upper end Pt2 of the tool changer 370 and the nozzle surface FN is focused on, the distance DI1 is preferably four times or less than a distance DI2 along the c1 direction between the upper end Pt3 of the tank portion 380 and the upper end Pt2 of the tool changer 370. The distance DI1 is an example of a “first distance”, and the distance DI2 is an example of a “second distance”. In the present embodiment, the distance DIa between the lower end Pb2 of the tool changer 370 and the nozzle surface FN is shortened. As a result, in the present embodiment, a distance between the distal end of the robot 2 and the lower end Pb1 of the head unit 3, for example, a distance DIc between a distal end Pat of the arm 226 shown in FIG. 5 and the lower end Pb1 of the head unit 3 can be shortened. As a result, in the present embodiment, the movable region of the head unit 3 can be secured.

In addition, in the present embodiment, the tool changer 370 is positioned in the a2 direction with respect to the drive substrate 340 and overlaps the drive substrate 340 as viewed from the a2 direction. As described above, in the present embodiment, since the drive substrate 340 is not between the tool changer 370 and the liquid discharge head 30, the distance between the tool changer 370 and the liquid discharge head 30 can be shortened.

Here, in the present embodiment, when the three-dimensional object printing apparatus 1 performs printing on the workpiece W, the operation of the robot 2 is controlled such that a moving direction of the liquid discharge head 30 is the a1 direction. Therefore, the a1 direction corresponds to the front in the moving direction of the liquid discharge head 30, and the a2 direction corresponds to the rear in the moving direction of the liquid discharge head 30.

In addition, in the present embodiment, the ink tank 38 is positioned in the front with respect to the liquid discharge head 30 in the moving direction of the liquid discharge head 30. For example, it is preferable that the ink tank 38 is positioned at a position farther from the base portion 210 than the liquid discharge head 30 in a state in which the nozzle surface FN faces vertically downward. Since the ink tank 38 is relatively large, the ink tank 38 is provided at a position that does not interfere with the arm 220 when the arm 220 is contracted, so that the movable region of the head unit 3 when the arm 220 is contracted can be secured.

In addition, in the present embodiment, since the head unit 3 includes the ink tank 38, the complication of the disposition of the pipe portion 350 for supplying ink to the liquid discharge head 30 can be reduced. For example, in a configuration where the head unit 3 does not include the ink tank 38, it is necessary to dispose a tube or the like for transporting ink from an outside of the head unit 3 to the liquid discharge head 30. Since the head unit 3 moves relative to the workpiece W, in a configuration where the head unit 3 includes the tube for transporting ink from the outside of the head unit 3 to the liquid discharge head 30, an attachment method, an installation place, and the like of the tube become issues. In addition, there is a concern that an operation range of the robot 2 may be restricted by the tube for transporting ink from the outside of the head unit 3 to the liquid discharge head 30. In the present embodiment, since the tube for transporting ink from the outside of the head unit 3 to the liquid discharge head 30 is not necessary, the configuration of the three-dimensional object printing apparatus 1 can be simplified, and the operation range of the robot 2 can be prevented from being restricted.

Next, an operation for opening a self-sealing valve 312 of the self-sealing unit 310 will be described with reference to FIG. 4.

FIG. 4 is an explanatory diagram for describing the operation for opening the self-sealing valve 312. FIG. 4 shows a cross section of the head unit 3 when the head unit 3 is cut by a plane parallel to an ac plane to include the self-sealing valve 312 of the self-sealing unit 310. In FIG. 4, in order to make the description easier to understand, a reservoir 302 to which the ink is supplied from the ink tank 38 via the pipe portion 350 shown in FIG. 3 is schematically shown among the elements included in the liquid discharge head 30. A capacity of ink that is storable in the ink tank 38 is larger than a capacity of ink that is storable in the reservoir 302.

The self-sealing unit 310 is a pressure adjustment mechanism that maintains the pressure of the ink in the reservoir 302 of the liquid discharge head 30 within a predetermined range. For example, the self-sealing unit 310 is provided in the pipe portion 350 shown in FIG. 4 that couples the liquid discharge head 30 and the ink tank 38. In the example shown in FIG. 4, the self-sealing unit 310 is attached to the surface of the first support portion 331 facing the c2 direction.

The self-sealing unit 310 includes, for example, a self-sealing valve 312 that is opened and closed in response to the pressure of the ink in the reservoir 302 of the liquid discharge head 30. For example, even when the posture of the head unit 3 changes, a negative pressure of ink in the reservoir 302 of the liquid discharge head 30 is maintained within a predetermined range by the opening and closing of the self-sealing valve 312. As described above, the self-sealing valve 312 adjusts a pressure applied to ink supplied from the ink tank 38 to the liquid discharge head 30. As a result, a flow rate of the ink that flows to the liquid discharge head 30 is adjusted. That is, the self-sealing valve 312 is a valve that adjusts the flow rate of the ink that flows to the liquid discharge head 30.

For example, when the tank portion 380 of the ink tank 38 is pressurized, the head unit 3 opens the self-sealing valve 312 of the self-sealing unit 310 by using the lever 314 and the valve opening and closing mechanism 316. Opening the self-sealing valve 312 means causing the self-sealing valve 312 to be in an open state. For example, the valve opening and closing mechanism 316 includes a movable portion 316a that moves along the c1 direction by an air pump or the like. In addition, among an end part 314a and an end part 314b of the lever 314, the end part 314a is an end part close to the movable portion 316a of the valve opening and closing mechanism 316, and the end part 314b is an end part close to the self-sealing valve 312 of the self-sealing unit 310.

For example, when the tank portion 380 of the ink tank 38 is pressurized, the valve opening and closing mechanism 316 pushes up the movable portion 316a in the c1 direction under the control of the controller 5. As a result, among the end part 314a and the end part 314b of the lever 314, the end part 314a pushed up by the movable portion 316a moves in a ca1 direction with a shaft PP of the lever 314 as a fulcrum, and the end part 314b moves in a ca2 direction with the shaft PP as a fulcrum. The ca1 direction is a direction between the a2 direction and the c1 direction, and the ca2 direction is a direction between the a1 direction and the c2 direction. In addition, the end part 314b of the lever 314 moves in the ca2 direction to push down the self-sealing valve 312 in the c2 direction. As a result, the self-sealing valve 312 is in an open state. As described above, in the present embodiment, the self-sealing valve 312 is opened by pressing the self-sealing valve 312 by using the lever 314 and the valve opening and closing mechanism 316. The lever 314 and the valve opening and closing mechanism 316 are examples of a “valve opening mechanism”.

In the present embodiment, since the lever 314 and the valve opening and closing mechanism 316 that open the self-sealing valve 312 are provided, pressurized cleaning can be appropriately executed. For example, depending on the type of the ink, such as an ultraviolet curable type of ink, the nozzle N is likely to be clogged. Even in this case, in the present embodiment, since the pressurized cleaning can be appropriately executed, the clogging of the nozzle N can be resolved or suppressed. In addition, in the pressurized cleaning, since the non-discharging of the ink due to the occurrence of cavitation caused by dissolved air in the ink is unlikely to occur, the reliability of the ink discharging of the head unit 3 is improved.

In addition, in the present embodiment, in the lever 314, a force point Pe1 that receives a force from the movable portion 316a of the valve opening and closing mechanism 316 is positioned in the a1 direction with respect to the tank portion 380 of the ink tank 38. That is, the force point Pe1 of the lever 314 is positioned in front of the tank portion 380 of the ink tank 38 in the moving direction of the liquid discharge head 30. For example, the force point Pe1 of the lever 314 is positioned at a position farther from the base portion 210 than the tank portion 380 of the ink tank 38 in a state in which the nozzle surface FN faces vertically downward. Therefore, the force point Pe1 of the lever 314 does not interfere with the robot 2. As a result, in the present embodiment, the movement of the end part 314a and the end part 314b of the lever 314 can be easily controlled.

In addition, in the present embodiment, since the force point Pe1 of the lever 314 is positioned in the a1 direction with respect to the tank portion 380 of the ink tank 38, the configuration of the head unit 3 can be simplified. As a result, in the present embodiment, even when the valve opening and closing mechanism 316 is provided, the distance DIa between the upper end Pt2 of the tool changer 370 and the lower end Pb1 of the head unit 3 can be shortened.

It is preferable that, when the tank portion 380 of the ink tank 38 is not pressurized, the end part 314b of the lever 314 is pushed up in the c1 direction by a spring or the like (not shown). In the present embodiment, when the tank portion 380 of the ink tank 38 is not pressurized, the lever 314 can be prevented from interfering with the opening and closing of the self-sealing valve 312 of the self-sealing unit 310. In addition, the mechanism that opens the self-sealing valve 312 is not limited to the example shown in FIG. 4. For example, in a configuration in which the self-sealing valve 312 is directly pressed, the lever 314 may be omitted. The configuration in which the self-sealing valve 312 is directly pressed may be, for example, a configuration in which a balloon is expanded to press the self-sealing valve 312.

Next, the head unit 3 mounted on the robot 2 will be described with reference to FIG. 5.

FIG. 5 is an explanatory diagram for describing the head unit 3 mounted on the robot 2. In FIG. 5, the head unit 3 and the like when the head unit 3 is viewed from the b2 direction are schematically shown. In FIG. 5, the switch circuit 32, which is not described in FIG. 4, is also described, not being limited to the features when the head unit 3 is mounted on the robot 2.

The switch circuit 32 is connected to the control module 34 mounted on the drive substrate 340 by the wiring member 320. For example, one end of the wiring member 320 is connected to the drive substrate 340, and the other end of the wiring member 320 is connected to the liquid discharge head 30 and the switch circuit 32. The wiring member 320 is, for example, a flexible flat cable. The wiring member 320 is not limited to the flexible flat cable. For example, the wiring member 320 may be a flexible wiring board.

When the head unit 3 is mounted on the robot 2, protruding portions Cax and Cd of the tool changer 240 of the robot 2 are inserted into recessed portions Hax and Hd of the tool changer 370, respectively. The protruding portion Cax and the recessed portion Hax are used for axis alignment, and the protruding portion Cd and the recessed portion Hd are used to align an orientation of the head unit 3 with respect to the arm 226 in a predetermined direction. By inserting the protruding portions Cax and Cd into the recessed portions Hax and Hd, respectively, the accuracy of mounting a plurality of the head units 3 on the robot 2 can be improved.

The tool changer 370 of the head unit 3 may be mounted on the tool changer 240 of the robot 2 via an adapter. That is, the head unit 3 being mounted on the robot 2 also includes the head unit 3 being mounted indirectly on the robot 2.

In addition, in the present embodiment, as described above, since the upper end Pt2 of the tool changer 370 is positioned between the upper end Pt1 and the lower end Pb1 of the head unit 3, the distance DIc between the lower end Pb1 of the head unit 3 coupled to the arm 226 and the distal end Pat of the arm 226 can be shortened. The distal end Pat of the arm 226 corresponds to the distal end of the robot 2. The lower end of the tool changer 240 may be regarded as the distal end of the robot 2. In the present embodiment, since the distance DIc between the distal end Pat of the arm 226 and the lower end Pb1 of the head unit 3 can be shortened, the movable region of the head unit 3 can be secured.

For example, in the c1 direction, the distal end Pat of the arm 226 is positioned between the upper end Pt1 and the lower end Pb1 of the head unit 3 coupled to the arm 226. As described above, in the present embodiment, when the head unit 3 is coupled to the arm 226, the lower end Pb1 of the head unit 3 can be brought close to the distal end Pat of the arm 226, so that the movable region of the head unit 3 can be secured.

In addition, in the present embodiment, in the c1 direction, a liquid level LS in the tank portion 380 in a state in which the tank portion 380 of the ink tank 38 is filled with the ink to a specific amount is positioned above the upper end Pt2 of the tool changer 370. The specific amount is, for example, an amount at which the tank portion 380 is full, and is an amount of about 80% to 90% with respect to the capacity of the tank portion 380. For example, a sensor (not shown) or the like that detects the remaining amount of the ink in the tank portion 380 is provided in the tank portion 380. In the present embodiment, since the liquid level LS when the tank portion 380 is filled with the ink to the specific amount is positioned above the upper end Pt2 of the tool changer 370, the liquid level LS is positioned above the liquid discharge head 30. Therefore, in the present embodiment, the hydraulic head of the ink in the tank portion 380 can be increased. That is, in the present embodiment, the pressure of the ink in the tank portion 380 can be increased.

In addition, in the present embodiment, in the c1 direction, the distance DIa between the lower end Pb2 of the tool changer 370 and the nozzle surface FN is shorter than a distance DIb between the lower end Pb2 of the tool changer 370 and the rotational axis O5. For example, the head unit 3 rotates about the rotational axis O5 during printing. In the present embodiment, since the distance DIa between the lower end Pb2 of the tool changer 370 and the nozzle surface FN can be shortened, a rotation radius when the head unit 3 rotates about the rotational axis O5 can be reduced. As a result, in the present embodiment, the head unit 3 can be accurately moved during printing.

Next, the backflow prevention mechanism 364 for ink will be described with reference to FIG. 6.

FIG. 6 is an explanatory diagram for describing the backflow prevention mechanism 364 for ink. In FIG. 6, the head unit 3 and the like when the head unit 3 is viewed from the b2 direction are schematically shown. In addition, FIG. 6 also shows an example of the configuration of the backflow prevention mechanism 364. In addition, in FIG. 6, the drive substrate 340 and the like are not shown in order to make the drawing easy to see.

The tank portion 380 of the ink tank 38 is configured to be, for example, substantially sealed. The ink tank 38 is configured to pressurize the tank portion 380 and open the tank portion 380 to the atmosphere. For example, the three-dimensional object printing apparatus 1 includes a pressurization mechanism 10 for supplying air to the tank portion 380 and opening the tank portion 380 to the atmosphere. The air is an example of a “gas”.

The pressurization mechanism 10 includes, for example, a pressure control mechanism 12 that controls the pressure in the tank portion 380 of the ink tank 38, a switching valve 14, a tube 16, and the backflow prevention mechanism 364. The pressure control mechanism 12 includes, for example, a pump (not shown) or the like.

The tube 16 is, for example, a tube that is coupled to the pressure control mechanism 12 and the tank portion 380 via the opening portion HO2 provided in the tool changer 240 and the opening portion HO1 provided in the tool changer 370 and through which air for controlling the pressure in the tank portion 380 passes. For example, the tube 16 includes a tube 160 coupled to the pressure control mechanism 12 and the switching valve 14, a tube 161 having one end coupled to the switching valve 14 and the other end opened to the atmosphere, a tube 162 coupled to the switching valve 14 and the opening portion HO2 of the tool changer 240, and the tube 362 coupled to the backflow prevention mechanism 364 and the ventilation port 384. The opening portion HO2 is a so-called air port through which air passes, the tube 162 is attached to one end, and the other end communicates with the opening portion HO1 of the tool changer 240. Therefore, the tube 162 is coupled to the backflow prevention mechanism 364 attached to the opening portion HO1 via the opening portion HO2 and the opening portion HO1. The tube 16 is an example of a “pipe”.

The switching valve 14 is a valve that switches a coupling destination of the tube 162. For example, the switching valve 14 couples the tube 162 and the tube 160 in a case of pressurizing the tank portion 380, and couples the tube 162 and the tube 161 in a case of opening the tank portion 380 to the atmosphere.

The backflow prevention mechanism 364 is provided between the tool changer 370 and the tank portion 380 in the tube 16, and prevents the ink from flowing back. For example, the backflow prevention mechanism 364 includes a gas-liquid selective permeable membrane 364a that blocks passage of a liquid and allows passage of a gas, housings 364b and 364c that hold the gas-liquid selective permeable membrane 364a, and an O-ring 364d disposed between the housing 364b and the gas-liquid selective permeable membrane 364a. The backflow prevention mechanism 364 may be coupled to the opening portion HO1 of the tool changer 370 via the tube.

As described above, in the present embodiment, since the pressurization mechanism 10 is provided, the pressure in the tank portion 380 of the ink tank 38 can be appropriately maintained. In addition, in the present embodiment, the pressurized cleaning is executed. The pressurization mechanism 10 or a part of the elements of the pressurization mechanism 10 may be regarded as an external element of the three-dimensional object printing apparatus 1. For example, the pressure control mechanism 12, the switching valve 14, the tube 160, and the tube 161 may be regarded as external elements of the three-dimensional object printing apparatus 1.

In addition, in the present embodiment, since the backflow prevention mechanism 364 is provided, the backflow of the ink to the tool changer 240 can be prevented. For example, the three-dimensional object printing apparatus 1 moves the head unit 3 with respect to the three-dimensional workpiece W to perform printing, so that the head unit 3 is inclined. Therefore, in a configuration in which the backflow prevention mechanism 364 is not provided, when the head unit 3 is inclined, the ink may flow back from the tank portion 380 of the ink tank 38 through the tube 16. For example, among the elements of the pressurization mechanism 10, the elements provided in the robot 2, such as the opening portion HO2 of the tool changer 240 and the tube 162, are reused with or without replacing the head unit 3. Therefore, when the head unit 3 is replaced in a state in which the ink that has flowed back from the tank portion 380 remains in the tool changer 240, ink of a different type may be mixed into the tank portion 380 when the tank portion 380 of the ink tank 38 included in the head unit 3 after the replacement is pressurized. In this case, the quality of the printing deteriorates. In the present embodiment, since the backflow of the ink to the tool changer 240 can be prevented by the backflow prevention mechanism 364, the deterioration of the quality of the printing can be suppressed.

The tube 16 may be formed of a resin tube, a plastic or metal pipe, or the like. In order to visually check the backflow of the ink, it is preferable that there is a transparent portion between the backflow prevention mechanism 364 and the tank portion 380. In the example shown in FIG. 6, it is preferable that the tube 362 is transparent.

In addition, a length of the ventilation port 384 is not particularly limited, but is preferably long from the viewpoint of preventing the backflow of the ink. In addition, from the viewpoint of preventing the backflow of the ink near the tank portion 380, the backflow prevention mechanism 364 is preferably provided at an end part of the ventilation port 384 in the c1 direction. In this case, the ventilation port 384 is preferably formed of a transparent plastic or the like.

In the present embodiment, as described above, in the c1 direction perpendicular to the nozzle surface FN, the nozzle surface FN is positioned at the lower end Pb1 of the head unit 3a. In the c1 direction, the upper end Pt2 of the tool changer 370 is positioned between the upper end Pt1 and the lower end Pb1 of the head unit 3a. That is, in the c1 direction, the upper surface SFtp of the tool changer 370 is positioned between the upper end Pt1 and the lower end Pb1.

In the present embodiment, since the upper end Pt2 of the tool changer 370 is positioned between the upper end Pt1 and the lower end Pb1 of the head unit 3, the distance DI1 between the upper end Pt2 of the tool changer 370 and the lower end Pb1 of the head unit 3 can be shortened. As a result, in the present embodiment, the movable region of the head unit 3 can be secured.

### 2. Modification Example

Each embodiment above can be variously modified. A specific embodiment of modification will be described below. Two or more aspects selected in any manner from the following examples can be appropriately combined with each other within a range consistent with each other. In addition, in the modification examples described below, elements having the same effects and functions as those of the embodiment will be given the reference numerals used in the description above, and each detailed description thereof will be appropriately omitted.

### First Modification Example

In the embodiment described above, the three-dimensional object printing apparatus 1 may include one or both of an irradiation section 250 that emits energy for curing the ink and a heating section 390 that heats the ink in the liquid discharge head 30.

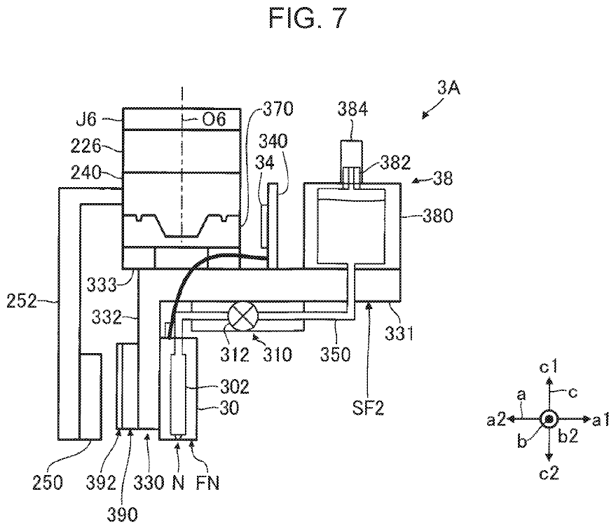

FIG. 7 is an explanatory diagram for describing a head unit 3A according to a first modification example. The head unit 3A is the same as the head unit 3 shown in FIG. 3 and the like, except that the heating section 390 is included. In addition, the robot 2 according to the present modification example is the same as the robot 2 shown in FIG. 1, except that the irradiation section 250 is included. That is, the three-dimensional object printing apparatus 1 according to the present modification example is the same as the three-dimensional object printing apparatus 1 shown in FIG. 1, except that the head unit 3A is included instead of the head unit 3 and the robot 2 includes the irradiation section 250.

The irradiation section 250 emits energy such as light, heat, an electron beam, or a radioactive ray for curing or solidifying the ink on the workpiece W. The irradiation section 250 may appropriately include an optical component such as a lens for adjusting an irradiation direction or an irradiation range of the energy. In the present modification example, the irradiation section 250 is attached to a support body 252 coupled to the tool changer 240. For example, the irradiation section 250 is attached to a surface of the support body 252 facing the a1 direction such that the irradiation section 250 is positioned in the a2 direction with respect to the liquid discharge head 30 in a state in which the head unit 3A is coupled to the tool changer 240.

The heating section 390 includes, for example, a heater and a thermocouple. For example, a temperature of the heater included in the heating section 390 is controlled by the controller 5 or the like based on a temperature measured by the thermocouple included in the heating section 390. A power supply voltage of the heating section 390 may be supplied from the power supply circuit 342 via the wiring member 320, may be supplied from the robot 2 via the wiring member 320, or may be supplied from the robot 2 without via the wiring member 320.

In the present modification example, the materials of the support body 330 and the tool changer 370 are preferably a rigid body such as a metal material having good thermal conductivity. The heating section 390 is attached to a surface of the second support portion 332 of the support body 330 facing the a2 direction such that the heating section 390 is positioned between the irradiation section 250 and the liquid discharge head 30. As a result, in the present modification example, the ink in the liquid discharge head 30 and the ink in the tank portion 380 can be heated.

In addition, in the example shown in FIG. 7, in order to prevent the heating section 390 from coming into contact with other members, a spacer 392 is attached to a surface of the heating section 390 facing the a2 direction. The material of the spacer 392 is preferably a material having thermal conductivity smaller than thermal conductivity of the support body 330 and thermal conductivity of the tool changer 370. For example, the material of the spacer 392 may be a resin. In addition, a thickness of the spacer 392 along the a2 direction is, for example, about 0.5 mm.

The configuration of the head unit 3A and the like according to the present modification example is not limited to the example shown in FIG. 7. For example, a thermal insulating material may be provided between the third support portion 333 of the support body 330 and the tool changer 370 or on the third support portion 333. In this case, the heat from the heater included in the heating section 390 can be suppressed from being transmitted to the arm 226. In addition, one of the irradiation section 250 or the heating section 390 need not be provided. That is, the irradiation section 250 and the heating section 390 may be appropriately provided.

In addition, for example, the irradiation section 250 may be provided in the head unit 3A. In addition, for example, the heating section 390 may be provided in the robot 2. Specifically, the heating section 390 may be provided between the arm 226 and the tool changer 240. In this case, it is preferable that a thermal insulating material is provided between the arm 226 and the heating section 390. In addition, when the heating section 390 is provided between the arm 226 and the tool changer 240, the materials of the tool changer 240, the support body 330, and the tool changer 370 are preferably a rigid body such as a metal material having good thermal conductivity.

As described above, in the present modification example as well, the same effects as those of the embodiment described above can be obtained.

### Second Modification Example

In the embodiment and the modification example described above, the case where the liquid discharge head 30 is provided on the rotational axis O6 is described as an example, but the present disclosure is not limited to such an aspect. For example, the liquid discharge head 30 may be provided to be positioned in the a1 direction with respect to the rotational axis O6.

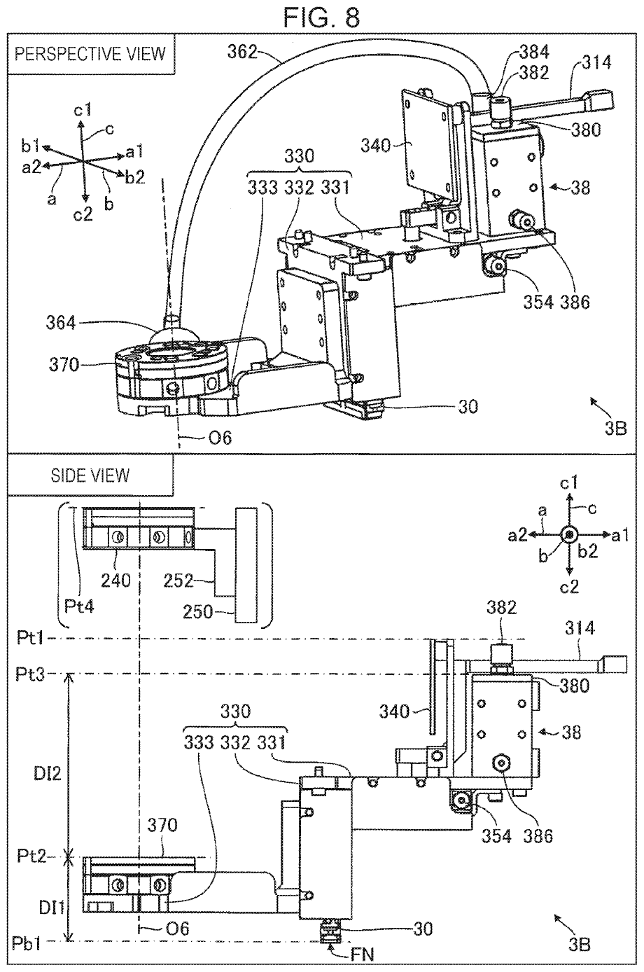

FIG. 8 is an explanatory diagram for describing a head unit 3B according to a second modification example. The upper part of FIG. 8 is a perspective view of the head unit 3B, and the lower part of FIG. 8 is a side view of the head unit 3B as viewed from the b2 direction. In addition, the tool changer 240 is also shown in the side view of FIG. 8.

The head unit 3B is the same as the head unit 3 shown in FIG. 3 and the like, except that the tool changer 370 is positioned in the a2 direction with respect to the liquid discharge head 30 and the valve opening and closing mechanism 316 is not included. In addition, the robot 2 according to the present modification example is the same as the robot 2 shown in FIG. 1, except that the irradiation section 250 is included. That is, the three-dimensional object printing apparatus 1 according to the present modification example is the same as the three-dimensional object printing apparatus 1 shown in FIG. 1, except that the head unit 3B is included instead of the head unit 3 and the robot 2 includes the irradiation section 250.

In the head unit 3B, the third support portion 333 of the support body 330 is provided to protrude in the a2 direction from an end part of the second support portion 332 in the c2 direction. The other configurations of the support body 330 are the same as those of the support body 330 of the head unit 3 shown in FIG. 3 and the like. The tool changer 370 is coupled to a surface, which faces the c1 direction, of the third support portion 333 that protrudes in the a2 direction from the end part of the second support portion 332 in the c2 direction. As a result, when the head unit 3B is mounted on the arm 226 via the tool changer 240, the liquid discharge head 30 is positioned in the a1 direction with respect to the rotational axis O6.

In the present modification example, the upper end Pt2 of the tool changer 370 is positioned between the upper end Pt1 and the lower end Pb1 of the head unit 3B, and the distal end Pat of the arm 226 is positioned between the upper end Pt1 and the lower end Pb1 of the head unit 3B coupled to the arm 226. In addition, in the present modification example, the distance DI1 along the c1 direction between the upper end Pt2 of the tool changer 370 and the nozzle surface FN is shorter than the distance DI2 along the c1 direction between the upper end Pt3 of the tank portion 380 and the upper end Pt2 of the tool changer 370. Therefore, in the present modification example, the distance DIc between the distal end Pat of the arm 226 and the lower end Pb1 of the head unit 3 can be shortened.

In addition, in the present modification example, the irradiation section 250 is attached to the support body 252 coupled to the tool changer 240. For example, the irradiation section 250 is attached to a surface of the support body 252 facing the a1 direction such that the irradiation section 250 is positioned between the tool changer 370 and the liquid discharge head 30 in a state in which the head unit 3B is coupled to the tool changer 240.

In the present modification example, the head unit 3B may include the heating section 390 as in the head unit 3A. For example, the heating section 390 may be attached to a surface of the second support portion 332 of the support body 330 facing the a2 direction such that the heating section 390 is positioned between the irradiation section 250 and the liquid discharge head 30. In addition, the irradiation section 250 need not be provided. That is, in the present modification example, the irradiation section 250 and the heating section 390 need only be appropriately provided.

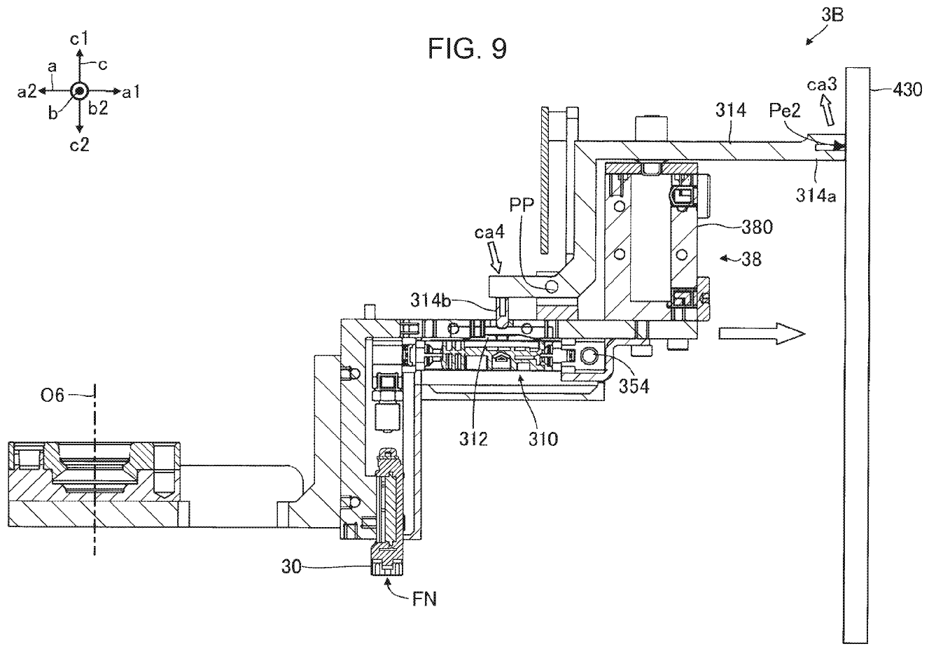

Next, an operation for opening the self-sealing valve 312 of the self-sealing unit 310 included in the head unit 3B will be described with reference to FIG. 9.

FIG. 9 is an explanatory diagram for describing another example of the operation for opening the self-sealing valve 312. FIG. 9 shows a cross section of the head unit 3B when the head unit 3B is cut by a plane parallel to the ac plane to include the self-sealing valve 312 of the self-sealing unit 310.

In the present modification example, for example, a flat plate-shaped abutting plate 430 extending in the Z1 direction is provided in the holding mechanism 4 shown in FIG. 1. For example, when the three-dimensional object printing apparatus 1 pressurizes the tank portion 380 of the ink tank 38, the robot 2 moves the head unit 3B such that the end part 314a of the lever 314 comes into contact with the abutting plate 430. Then, the robot 2 moves the head unit 3B in the a1 direction such that the head unit 3B is pressed against the abutting plate 430 in a state in which the end part 314a of the lever 314 comes into contact with the abutting plate 430. As a result, the end part 314a of the lever 314 moves in a ca3 direction with the shaft PP of the lever 314 as a fulcrum, and the end part 314b of the lever 314 moves in a ca4 direction with the shaft PP as a fulcrum. The ca3 direction is a direction between the a2 direction and the c1 direction, and the ca4 direction is a direction between the a1 direction and the c2 direction.

The end part 314b of the lever 314 moves in the ca4 direction to push down the self-sealing valve 312 in the c2 direction. As a result, the self-sealing valve 312 is in an open state. As described above, in the present modification example, the robot 2 moves the head unit 3B to press the end part 314a of the lever 314 against the abutting plate 430, so that the self-sealing valve 312 is opened.

In the present modification example, in the lever 314, a force point Pe2 that receives a force from the abutting plate 430 is positioned in the a1 direction with respect to the tank portion 380 of the ink tank 38. For example, the force point Pe2 of the lever 314 is positioned at a position farther from the base portion 210 than the tank portion 380 of the ink tank 38 in a state in which the nozzle surface FN faces vertically downward. Therefore, in the present modification example, since the force point Pe2 of the lever 314 does not interfere with the robot 2, the movement of the end part 314a and the end part 314b of the lever 314 can be easily controlled.

In addition, in the present modification example, since the force point Pe2 of the lever 314 is positioned in the a1 direction with respect to the tank portion 380 of the ink tank 38, the configuration of the head unit 3B can be simplified.

In the present modification example, the valve opening and closing mechanism 316 may be provided in the head unit 3B. Alternatively, in the embodiment described above, as in the present modification example, the robot 2 may move the head unit 3B to press the end part 314a of the lever 314 against the abutting plate 430 without providing the valve opening and closing mechanism 316, so that the self-sealing valve 312 is opened.

As described above, in the present modification example as well, the same effects as those of the embodiment and the modification examples described above can be obtained.

### Third Modification Example

In the embodiment and the modification example described above, the case where the head units 3, 3A, or 3B include the control module 34 is described as an example, but the present disclosure is not limited to such an aspect. For example, a part or all of the power supply circuit 342, the timing signal generation circuit 344, the control circuit 346, and the drive signal generation circuit 348 included in the control module 34 may be provided outside the head units 3, 3A, or 3B. Specifically, for example, the robot 2 may include the power supply circuit 342, the timing signal generation circuit 344, the control circuit 346, and the drive signal generation circuit 348. Alternatively, for example, the head units 3, 3A, or 3B may include the drive signal generation circuit 348, and the robot 2 may include the power supply circuit 342, the timing signal generation circuit 344, and the control circuit 346. In the present modification example as well, the same effects as those of the embodiment and the modification examples described above can be obtained.

### Fourth Modification Example

In the embodiment and modification examples described above, a case where the three-dimensional object printing apparatus 1 includes the maintenance unit 46 is described as an example, but the present disclosure is not limited to such an aspect. For example, the three-dimensional object printing apparatus 1 need not include the maintenance unit 46. In the present modification example as well, the same effects as those of the embodiment and the modification examples described above can be obtained.

What is claimed is:

1. A three-dimensional object printing apparatus comprising:
a first head unit including a first head that discharges liquid; and
a robot that moves the first head unit with respect to a workpiece in a state in which the first head unit is mounted on the robot, wherein
the first head unit includes a coupling portion that is coupled to a distal end of the robot,
the first head includes a nozzle surface provided with a nozzle that discharges the liquid,
the nozzle surface is positioned at a lower end of the first head unit in a first direction perpendicular to the nozzle surface, and
an upper end of the coupling portion is positioned between an upper end and the lower end of the first head unit in the first direction.

2. The three-dimensional object printing apparatus according to claim 1, wherein
the robot includes a first arm that is coupled to the first head unit and rotates about a first rotational axis, and
a distal end of the first arm is positioned between the upper end and the lower end of the first head unit in the first direction in a state where the first head unit is coupled to the first arm.

3. The three-dimensional object printing apparatus according to claim 1, wherein
the first head unit includes a storage section that stores the liquid that is supplied to the first head, and
the coupling portion is positioned in a second direction parallel to the nozzle surface with respect to the storage section, and overlaps the storage section as viewed from the second direction.

4. The three-dimensional object printing apparatus according to claim 3, wherein
in the first direction, a first distance between the upper end of the coupling portion and the nozzle surface is four times or less than a second distance between an upper end of the storage section and the upper end of the coupling portion.

5. The three-dimensional object printing apparatus according to claim 3, wherein
the robot includes a base portion and a plurality of arms that couple the base portion to the first head unit, and
the storage section is positioned farther from the base portion than the first head in a state in which the nozzle surface faces vertically downward.

6. The three-dimensional object printing apparatus according to claim 3, wherein
in the first direction, a liquid level in the storage section in a state in which the storage section is filled with the liquid to a specific amount is positioned above the upper end of the coupling portion.

7. The three-dimensional object printing apparatus according to claim 3, further comprising:
a pipe that is coupled, via the coupling portion, to a pressure control mechanism that controls a pressure in the storage section and to the storage section and through which a gas for controlling the pressure in the storage section passes.

8. The three-dimensional object printing apparatus according to claim 7, further comprising:
a backflow prevention mechanism that prevents a liquid from flowing back between the coupling portion and the storage section in the pipe.

9. The three-dimensional object printing apparatus according to claim 1, wherein
the first head unit includes a first drive substrate including a first drive circuit that drives the first head, and
the coupling portion is positioned in a second direction parallel to the nozzle surface with respect to the first drive substrate, and overlaps the first drive substrate as viewed from the second direction.

10. The three-dimensional object printing apparatus according to claim 1, wherein
the robot includes
a first arm that is coupled to the first head unit and rotates about a first rotational axis, and
a second arm that is coupled to the first arm and rotates about a second rotational axis different from the first rotational axis, and
in the first direction, a distance between a lower end of the coupling portion and the nozzle surface is shorter than a distance between the lower end of the coupling portion and the second rotational axis.

11. The three-dimensional object printing apparatus according to claim 1, further comprising:
a second head unit including a second head that discharges liquid, wherein
the robot moves the first head unit with respect to the workpiece in a state in which the first head unit is mounted on the robot, and moves the second head unit with respect to the workpiece in a state in which the second head unit is mounted on the robot, and
the first head unit and the second head unit are automatically attached to and detached from the robot.

12. The three-dimensional object printing apparatus according to claim 1, wherein
the robot includes a first arm that is coupled to the first head unit and rotates about a first rotational axis, and
the first head is positioned below the coupling portion in the first direction, and overlaps the first rotational axis as viewed from the first direction.

13. The three-dimensional object printing apparatus according to claim 1, further comprising:
a valve that adjusts a flow rate of the liquid that flows to the first head; and
a valve opening mechanism configured to open the valve by applying a pressing force to the valve.

14. A head unit including an upper end and a lower end, the head unit comprising:
a head that discharges liquid; and
a coupling portion configured to be coupled to a distal end of a robot, wherein
the head includes a nozzle surface provided with a nozzle that discharges the liquid,
the nozzle surface is positioned at the lower end in a first direction perpendicular to the nozzle surface, and
an upper surface of the coupling portion is positioned between the upper end and the lower end in the first direction.
